(19) United States
(12) Patent Application Publication
(10) Pub. No.: US 2025/0238218 A1
(43) Pub. Date: Jul. 24, 2025

(54) CONTAINER REGISTRY MANAGEMENT SYSTEM

(71) Applicant: Electronics and Telecommunications Research Institute, Daejeon (KR)

(72) Inventor: Siwoon SON, Daejeon (KR)

(73) Assignee: Electronics and Telecommunications Research Institute, Daejeon (KR)

(21) Appl. No.: 19/019,716

(22) Filed: Jan. 14, 2025

(30) Foreign Application Priority Data
Jan. 18, 2024 (KR) 10-2024-0008219
Aug. 5, 2024 (KR) 10-2024-0104158

(51) Int. Cl. G06F 8/61; G06F 21/51

(52) U.S. Cl. CPC G06F 8/63; G06F 21/51; G06F 2221/033

(57) ABSTRACT

Disclosed is a container registry management system including a registry management device that manages a plurality of container registries, a source code management device that receives a source code from a first user, builds a first container image based on a request signal of the first, and pushes the first container image to a first container registry within the plurality of container registries, based on a request signal of the first user, a user management device that manages a first image access permission of a second user for the first container image based on a request signal of the first user and manages a first access permission of the first user for the plurality of container registries and a second access permission of the second user for the plurality of container registries, and a data storage device that stores data related to the registry management device.

### CROSS-REFERENCE TO RELATED APPLICATIONS

This application claims priority under 35 U.S.C. § 119 to Korean Patent Application No. 10-2024-0008219 filed on Jan. 18, 2024, and No. 10-2024-0104158 filed on Aug. 5, 2024, in the Korean Intellectual Property Office, the disclosures of which are incorporated by reference herein in their entireties.

### BACKGROUND

Embodiments of the present disclosure described herein relate to a data management system, and more particularly, relate to a container registry management system that manages a plurality of container registries.

Nowadays, with the development of a cloud technology, a microservice architecture method, which allows applications to be divided and configured in independent environments, is being introduced unlike a conventional monolithic method. Due to the activation of microservice technology, application tasks are being created and executed based on containers. Compared to the conventional monolithic method, container-based application tasks have high productivity, reusability, functional decomposition, language independence, flexibility, and resource lightness.

To implement a microservice as a container, there is a need for a process of building a source code, a library file, and the like, which are required for the microservice to operate, into a container image composed of binary data. Conventional developers have generated container images in a method of building the source code in a local environment.

Nowadays, there has been an increase in container-based application tasks that utilize a plurality of container registries among a plurality of users. Accordingly, the need for a system that manages the plurality of container registries is emerging.

### SUMMARY

Embodiments of the present disclosure provide a container registry management system that integrally manages a source code, a container image, and users.

According to an embodiment, a container registry management system includes a registry management device that manages a plurality of container registries, a source code management device that receives a source code from a first user, builds a first container image based on a request signal of the first user for building the first container image, and pushes the first container image to a first container registry within the plurality of container registries, based on a request signal of the first user for pushing the first container image, a user management device that manages a first image access permission of a second user for the first container image based on a request signal of the first user related to an access permission of the second user for the first container image, and manages a first access permission of the first user for the plurality of container registries and a second access permission of the second user for the plurality of container registries, and a data storage device that stores data related to the registry management device, the source code management device, and the user management device.

In some embodiments for solving the above-described problems, the data storage device includes a user information storage device that stores information about the first image access permission, the first access permission, and the second access permission, a registry information storage device that stores information about the plurality of container registries and password information about the plurality of container registries, and a source code information storage device that stores information about the source code and information about the first container image. In some embodiments for solving the above-described problems, the registry management device includes a registry adding device that adds a second container registry and a password for the second container registry to the registry information storage device, a registry modifying device that modifies description information about the second container registry and the password for the second container registry in the registry information storage device, and a registry deleting device that deletes information about the second container registry from the registry information storage device, deletes a second container image stored in the second container registry from the source code information storage device, and deletes an access permission of a user for the second container image from the user information storage device.

In some embodiments for solving the above-described problems, the registry management device further includes a registry operation verifying device that verifies validity of administrator account information and an API address of the second container registry prior to operations of the registry adding device, the registry modifying device, and the registry deleting device.

In some embodiments for solving the above-described problems, the user management device includes a user adding device that stores an access permission of a third user for the plurality of container registries and user information about the third user in the user information storage device, a user modifying device that modifies information about the third user stored in the user information storage device, a user deleting device that deletes the information about the third user stored in the user information storage device, an image member adding device that adds the first image access permission of the second user for the first container image based on a request signal of the first user, and an image member deleting device that deletes the first image access permission based on the request signal of the first user.

In some embodiments for solving the above-described problems, the user management device further includes a user information verifying device that verifies validity of a data type and a character pattern of a user ID, a password, a name, and an email address of each of the first user, the second user, and the third user prior to operations of the user adding device, the user modifying device, the user deleting device, the image member adding device, and the image member deleting device.

In some embodiments for solving the above-described problems, the source code management device includes a source code adding device that receives and stores the source code from the first user in the source code information storage device, a source code deleting device that deletes the source code from the source code information storage device based on a request of the first user for deleting the source code, an image building device that builds the source code into the first container image based on a request signal of the first user for building the first container image, an image pushing device that pushes the first container image to the first container registry based on a request signal of the first user for pushing the first container image, and an image deleting device that deletes the first container image from the first container registry based on a request signal of the first user for deleting the first container image and deletes information about the first container image from the source code information storage device.

In some embodiments for solving the above-described problems, the source code management device further includes a source code and image verifying device that verifies validity of a data type and a character pattern of the source code and the first container image, and a file structure of the source code and the first container image prior to operations of the source code adding device, the source code deleting device, the image building device, the image pushing device, and the image deleting device.

According to an embodiment, a container registry management method of a container registry management system including a source code management device, a user management device, and a plurality of container registries includes receiving, by the source code management device, a source code from a first user, building, by the source code management device, the source code into a first container image based on a request signal of the first user for building the first container image, pushing, by the source code management device, the first container image to a first container registry within the plurality of container registries based on a request signal of the first user for pushing the first container image, and assigning, by the user management device, an access permission for the first container image to a second user based on a request signal of the first user related to an access permission of the second user for the first container image.

In some embodiments for solving the above-described problems, the container registry management method further includes deleting, by the user management device, the access permission of the second user for the first container image based on a request signal of the first user for deleting the access permission of the second user for the first container image.

In some embodiments for solving the above-described problems, the container registry management method further includes verifying validity of data types, and character patterns of user IDs, passwords, names, and email addresses of the first user and the second user.

In some embodiments for solving the above-described problems, the container registry management method further includes verifying validity of a data type and a character pattern of the source code and the first container image, and a file structure of the source code and the first container image.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a container registry management system, according to an embodiment of the present disclosure.

FIG. 2 is a diagram showing each configuration of a data storage device, according to an embodiment of the present disclosure.

FIG. 3 is a diagram showing each configuration of a registry management device, according to an example of the present disclosure.

FIG. 4 is a diagram showing each configuration of a user management device, according to an example of the present disclosure.

FIG. 5 is a diagram showing each configuration of a source code management device, according to an example of the present disclosure.

FIG. 6 is a diagram showing a method in which a container registry management system builds and pushes a source code and manages a user.

### DETAILED DESCRIPTION

The present disclosure is not limited to embodiments disclosed below, but may be implemented in many forms and subject to various modifications and changes. However, the description of the embodiments is provided to make the disclosure of the present disclosure complete and to fully disclose the scope of the present disclosure to those having ordinary skill in the art to which it belongs.

In various embodiments of the present disclosure, terms such as first, second, third, and the like are used to describe various components, but these components should not be limited by such terms. These terms are only used to distinguish one component from another component. The embodiments described herein include complementary embodiments thereof.

In the specification, the singular forms include plural forms unless particularly mentioned. The terms “comprises” and/or “comprising,” when used in the specification, specify the presence of steps, operations, elements, and/or components, but do not preclude the presence or addition of one or more other steps, operations, elements, components, and/or groups thereof.

Hereinafter, embodiments of the present disclosure will be described in detail and clearly to such an extent that an ordinary one in the art easily implements the present disclosure.

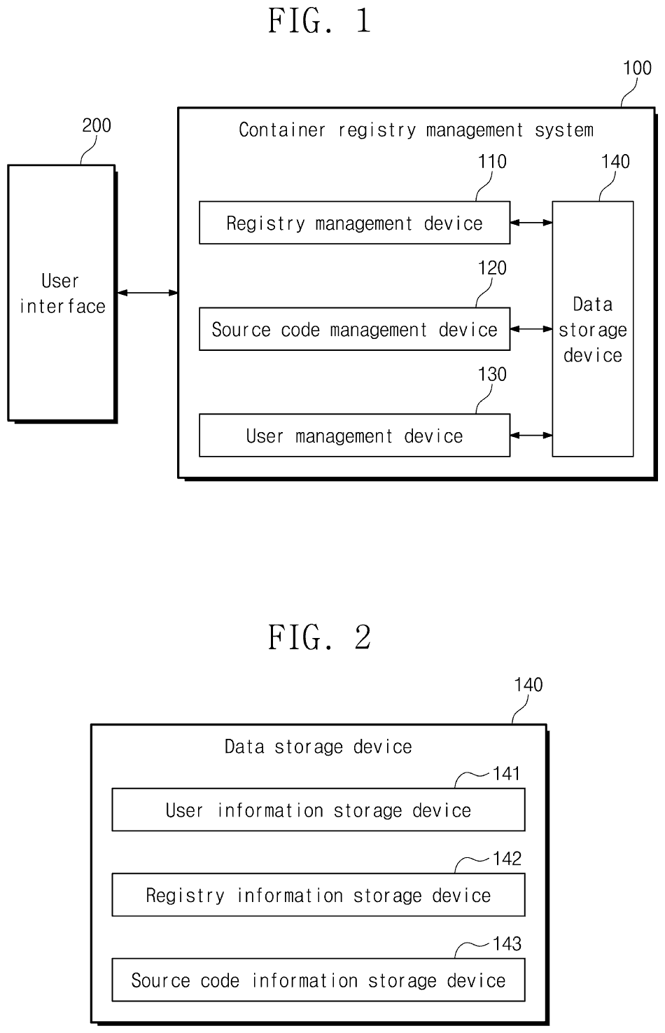

FIG. 1 is a diagram illustrating a container registry management system 100, according to an embodiment of the present disclosure.

Referring to FIG. 1, the container registry management system 100 may include a registry management device 110, a source code management device 120, a user management device 130, and a data storage device 140.

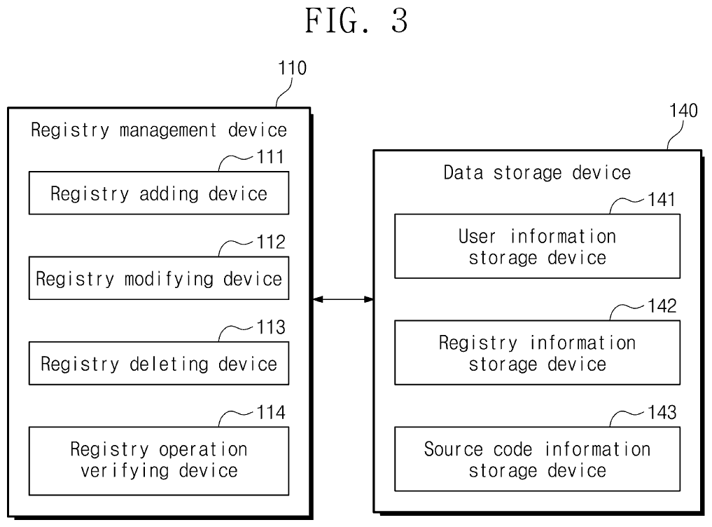

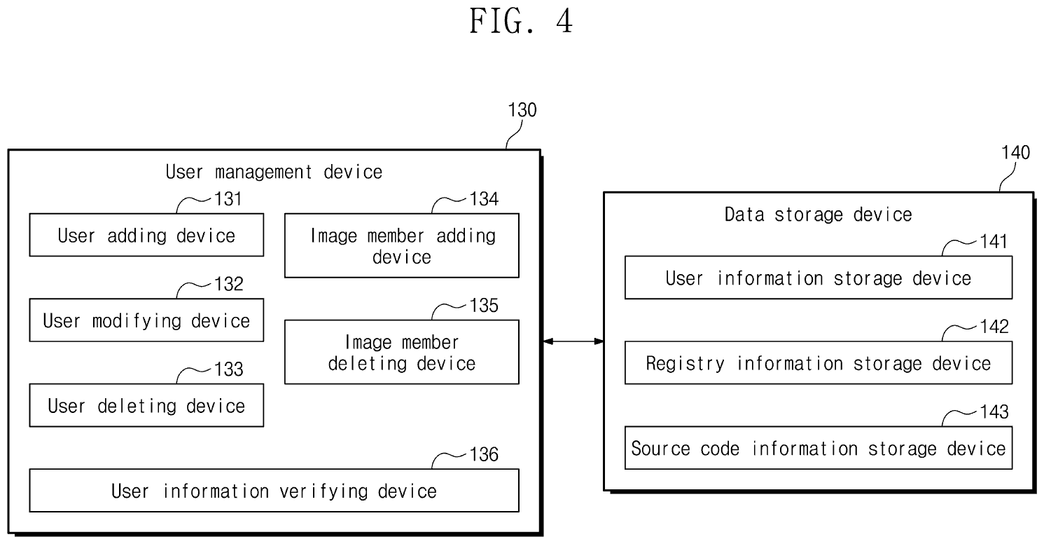

The registry management device 110 may be configured to manage a plurality of container registries. For example, the registry management device 110 may be configured to add a new container registry to a plurality of container registries used by the container registry management system 100, or to modify or delete an existing container registry. For example, each of the plurality of container registries may be configured to store a plurality of container images. For example, the registry management device 110 may be configured to store information about the plurality of container registries in the data storage device 140. For example, each of the plurality of container registries may be implemented as Docker Hub, Harbor, Nexus, Google Container Registry, or the like. Detailed descriptions of the registry management device 110 will be described later with reference to FIG. 3.

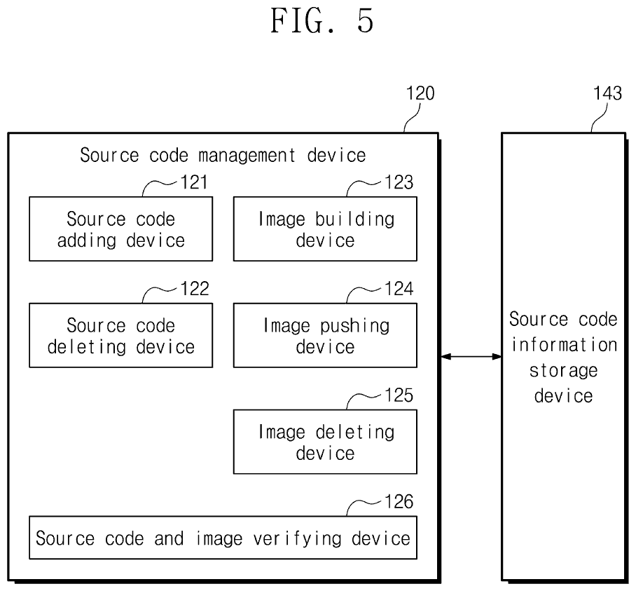

The source code management device 120 may be configured to receive a source code from a user, to build a container image, and to push the container image to the plurality of container registries. For example, the source code management device 120 may be configured to receive the source code from the user through a user interface 200. For example, the source code management device 120 may be configured to generate the source code, which is received from the user, as a container image based on the user's container image build request signal. For example, through Docker, the source code management device 120 may be configured to generate the source code as the container image. For example, the source code management device 120 may be configured to store the generated container image in one or more of the plurality of container registries based on the user's container image push request signal. For example, the user's container image push request signal may include container registries where the generated container image is to be stored. For example, the source code management device 120 may be configured to store information about the source code and information about the container image in the data storage device 140. Detailed descriptions of the source code management device 120 will be described later with reference to FIG. 5.

The user management device 130 may be configured to manage access permissions of users for the container registry management system 100. For example, the user management device 130 may be configured to add, modify, and delete information about users who have access to the container registry management system 100. For example, an administrator of the container registry management system 100 may manage the access permissions of the users for the container registry management system 100 through the user management device 130. For example, the user management device 130 may be configured to store information about access permissions for the container registry management system 100 in the data storage device 140. For example, when a first user attempts to access the container registry management system 100, the user management device 130 may be configured to identify the access permission of the first user on the data storage device 140 and to determine whether to allow access. For example, when the access is allowed, the first user may access the plurality of container registries.

The user management device 130 may be configured to manage the access permissions of users for each container image stored in the plurality of container registries. For example, the user management device 130 may be configured to store information about the access permissions of the users for each container image in the data storage device 140. For example, when the first user pushes a first container image to the plurality of container registries, the first user may manage the access permission of the second user through the user management device 130. For example, the user management device 130 may be configured to add, modify, or delete the image access permission for the first container image of the second user to the data storage device 140 based on the request signal of the first user. For example, when the second user attempts to access the first container image, the user management device 130 may be configured to identify the second user's access permission on the data storage device 140 and to determine whether access is permitted. For example, when the access is permitted, the second user may access the first container image. Detailed descriptions of the user management device 130 will be described later with reference to FIG. 4.

The data storage device 140 may be configured to store data related to the container registry management system 100. For example, the data storage device 140 may be configured to store data related to the registry management device 110, the source code management device 120, and the user management device 130. Detailed descriptions of a data management device will be described later with reference to FIG. 2.

The user interface 200 may be configured to deliver requests of users to the container registry management system 100. For example, the container registry management system 100 may be connected to the user interface 200 to exchange signals. For example, a user may access a plurality of container registries through the user interface 200. For example, the user interface 200 may be configured to receive a user input by using electronic devices such as a monitor, a keyboard, and a mouse.

With this configuration, the container registry management system 100 may receive a source code from a user, may build a container image, and may push the built container image to a plurality of container registries. Moreover, the container registry management system 100 may easily manage a user capable of accessing each container image stored in the plurality of container registries.

Through the container registry management system 100 of the present disclosure, a container image build function may be provided while the plurality of container registries may be integrated and managed, thereby increasing the convenience of development for users and improving the scalability of container images. Furthermore, container images may be easily shared and managed between heterogeneous container registry users by providing a user sharing function for individual container images.

FIG. 2 is a diagram showing each configuration of the data storage device 140, according to an embodiment of the present disclosure. Hereinafter, the description will be given with reference to FIG. 1.

The data storage device 140 may include a user information storage device 141, a registry information storage device 142, and a source code information storage device 143.

The user information storage device 141 may be configured to store information about users' access permissions for the container registry management system 100. For example, the information about the users' access permissions may include a user's ID, password, name, email address, or the like.

The user information storage device 141 may be configured to store information about users' access permissions for each container image stored in a plurality of container registries. For example, the user information storage device 141 may be configured to store the ID of a user who has access to each container image.

The registry information storage device 142 may store information about a plurality of container registries. For example, the information about a plurality of container registries may include access information of the plurality of container registries, API addresses, an administrator account's ID, or the like. The registry information storage device 142 may be configured to store passwords of an administrator and users. For example, the registry information storage device 142 may be configured to store passwords, which are used as users access each container image registry and which are stored in the user information storage device 141. For example, the registry information storage device 142 may be configured to store a password of the administrator account.

The source code information storage device 143 may be configured to store information about a source code received from a user. For example, the source code information storage device 143 may be configured to transmit the first source code to the source code management device 120 based on the user's first container image build request signal.

The source code information storage device 143 may be configured to store information about a container image. For example, the source code information storage device 143 may be configured to store a first container image's build status, build start time, build end time, container image size, or the like based on the user's first container image build request signal. For example, the source code information storage device 143 may be configured to store the first container image's push status, push start time, push end time, or the like based on the user's first container image push request signal.

FIG. 3 is a diagram showing each configuration of the registry management device 110, according to an example of the present disclosure. Hereinafter, the description will be given with reference to FIG. 1.

The registry management device 110 may include a registry adding device 111, a registry modifying device 112, a registry deleting device 113, and a registry operation verifying device 114.

The registry adding device 111 may be configured to add a new container registry to the container registry management system 100. For example, the registry adding device 111 may add a second container registry to the container registry management system 100. For example, the registry adding device 111 may add a second container registry based on an administrator's request to add the second container registry. For example, the registry adding device 111 may be configured to determine whether it is accessible, by communicating with the second container registry. When access to the second container registry is possible, the registry adding device 111 may generate an account of the second container registry in bulk based on users' information. For example, information of users may include a user's ID, password, name, email address, or the like. For example, the registry adding device 111 may receive the users' information from the user information storage device 141 and may generate an account of the second container registry. For example, when the account of the second container registry is generated, the registry adding device 111 may be configured to store information about the second container registry and a password for the second container registry in the registry information storage device 142. For example, the password for the second container registry may include the passwords of the users and the administrator.

The registry modifying device 112 may be configured to modify the passwords and description information of a plurality of container registries. For example, the registry modifying device 112 may be configured to identify the modified information of each of the container registries by communicating with the plurality of container registries, and to modify and store the identified information in the registry information storage device 142. For example, the registry modifying device 112 may be configured to modify a password for a container registry. For example, the registry modifying device 112 may be configured to modify the password for the container registry based on a request to modify the passwords of the users and the administrator.

The registry deleting device 113 may be configured to delete a container registry from the registry information storage device 142. For example, the registry deleting device 113 may be configured to delete information about the second container registry from the registry information storage device 142. For example, the registry deleting device 113 may be configured to delete information about the second container registry based on the administrator's request to delete the second container registry.

For example, when the second container registry is deleted, the registry deleting device 113 may be configured to delete the second container image, which is stored in the second container registry, from the source code information storage device 143. For example, the registry deleting device 113 may be configured to change a push status of the second container image into “Deleted” in the source code information storage device 143.

For example, when the second container registry is deleted, the registry deleting device 113 may be configured to delete the user's access permission for the second container image, which is stored in the second container registry, from the user information storage device 141.

Prior to operations of the registry adding device 111, the registry modifying device 112, and the registry deleting device 113, the registry operation verifying device 114 may be configured to verify the validity of the operations. For example, the registry operation verifying device 114 may be configured to verify the validity of administrator account information and an API address of the second container registry when the second container registry is added, modified, and/or deleted. For example, the validity of administrator account information may include information about the validity of the data type and character pattern of the administrator account's ID and password.

FIG. 4 is a diagram showing each configuration of the user management device 130, according to an example of the present disclosure. Hereinafter, the description will be given with reference to FIG. 1.

The user management device 130 may include a user adding device 131, a user modifying device 132, a user deleting device 133, an image member adding device 134, an image member deleting device 135, and a user information verifying device 136.

The user adding device 131 may be configured to add a new user to the container registry management system 100. For example, the user adding device 131 may be configured to store the access permission of a third user for a plurality of container registries and user information of the third user in the user information storage device 141. For example, the third user may be added based on an administrator's request to add the third user. For example, the user adding device 131 may be configured to generate accounts of a plurality of container registries as third user information and may store the accounts in the user information storage device 141. For example, when the third user information is stored in the user information storage device 141, the user adding device 131 may be configured to store the third user's password in the registry information storage device 142.

The user modifying device 132 may be configured to modify information about a user stored in the user information storage device 141. For example, the user modifying device 132 may be configured to modify the third user's information in the user information storage device 141 based on a request to modify information of the third user. For example, the third user's information may include the third user's ID, password, name, email address, or the like. For example, when the password of the third user is modified, the user modifying device 132 may be configured to modify the password of the third user in the registry information storage device 142.

The user deleting device 133 may be configured to delete information about a user stored in the user information storage device 141. For example, the user modifying device 132 may be configured to delete the third user's information from the user information storage device 141 based on an administrator's request to delete the third user. For example, when information of a third user is deleted, the user deleting device 133 may be configured to delete information related to the third user from the registry information storage device 142 and the source code information storage device 143. For example, the information related to the third user in the registry information storage device 142 may include the third user's password. For example, the information related to the third user in the source code information storage device 143 may include a source code entered by the third user, a container image, and container image information authorized to the third user.

The image member adding device 134 may be configured to add a user's access permission for each container image stored in a plurality of container registries. For example, when the first user builds and pushes a first container image, the first user may add the access permission for the second user. For example, the image member adding device 134 may be configured to add the second user's access permission for the first container image to the user information storage device 141 based on the first user's request to add the access permission of the second user.

The image member deleting device 135 may be configured to delete a user's access permission for each container image stored in a plurality of container registries. For example, when the first user builds and pushes the first container image, the first user may delete the access permission for the second user. For example, the image member deleting device 135 may be configured to delete the second user's access permission for the first container image to the user information storage device 141 based on the first user's request to delete the access permission of the second user.

Prior to operations of the user adding device 131, the user modifying device 132, the user deleting device 133, the image member adding device 134, and the image member deleting device 135, the user information verifying device 136 may be configured to verify the validity of the operations. For example, the user information verifying device 136 may be configured to verify the validity of the data type and character pattern of the user ID, password, name, and email address of each of the first to third users.

FIG. 5 is a diagram showing each configuration of the source code management device 120, according to an example of the present disclosure. Hereinafter, the description will be given with reference to FIG. 1.

The source code management device 120 may include a source code adding device 121, a source code deleting device 122, an image building device 123, an image pushing device 124, an image deleting device 125, and a source code and image verifying device 126.

The source code adding device 121 may be configured to receive a source code from a user and to store the source code in the source code information storage device 143. For example, when a first user enters a first source code into the user interface 200, the source code adding device 121 may be configured to store the first source code into the source code information storage device 143. For example, before storing the first source code, the source code adding device 121 may be configured to verify that the first source code is capable of being built into a container image.

The source code deleting device 122 may be configured to delete the source code from the source code information storage device 143. For example, the source code deleting device 122 may be configured to delete a first source code from the source code information storage device 143 based on a first user's request to delete the first source code.

The image building device 123 may be configured to build the source code into the container image. For example, the first user may deliver a first container image build request signal to the image building device 123. For example, the image building device 123 may be configured to build the first source code into the first container image based on the first container image build request signal of the first user. For example, the image building device 123 may be configured to generate the first source code as the first container image through Docker. For example, when the first container image is generated, the image building device 123 may be configured to change a build status of the first container image into “Completed” in the source code information storage device 143. For example, when the first container image is generated, the image building device 123 may be configured to store the first container image's build start time, build end time, image size, or the like in the source code information storage device 143. For example, when an error occurs in a process of building the first container image, the image building device 123 may be configured to change the build status of the first container image into “Error” in the source code information storage device 143.

The image pushing device 124 may be configured to push a container image to a container registry. For example, the image pushing device 124 may be configured to push the first container image to the first container registry based on the first user's first container image push request signal. For example, the first user's first container image push request signal may include information about the first container registry where the first container image is to be pushed. For example, when the first container image is pushed, the image pushing device 124 may be configured to change the push status of the first container image into “Completed” in the source code information storage device 143. For example, when the first container image is pushed, the image pushing device 124 may be configured to store the first container image's push start time, push end time, or the like in the source code information storage device 143. For example, when an error occurs in a process of pushing the first container image, the image pushing device 124 may be configured to change the push status of the first container image into “Error” in the source code information storage device 143.

The image deleting device 125 may be configured to delete a container image from the container registry. For example, the image deleting device 125 may be configured to delete the first container image from the first container registry based on the first user's first container image deletion request signal. For example, when the first container image is deleted from the first container registry, the image deleting device 125 may be configured to delete information about the first container image from the source code information storage device 143. For example, information about the first container image may include the first container image's build status, build start time, build end time, container image size, push status, push start time, and push end time.

Prior to operations of the source code adding device 121, the source code deleting device 122, the image building device 123, the image pushing device 124, and the image deleting device 125, the source code and image verifying device 126 may be configured to verify the validity of operations. For example, the source code and image verifying device 126 may be configured to verify the validity of a data type and a character pattern of the first source code and the first container image and a file structure of the first source code and the first container image.

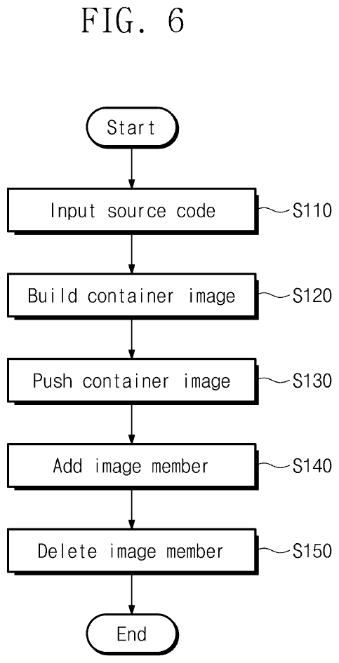

FIG. 6 is a diagram showing a method in which the container registry management system 100 builds and pushes a source code and manages a user. Hereinafter, the description will be given with reference to FIG. 1.

As in the operation of the container registry management system 100 described above with reference to FIGS. 1 to 5, in each operation, devices included in the container registry management system 100 may be configured to perform operations similar to those described above.

In operation S110, the source code management device 120 may receive a first source code from a first user. For example, the first user may input the first source code through the user interface 200, and the user interface 200 may be configured to transmit the first source code to the container registry management system 100.

In operation S120, the source code management device 120 may build the first source code into a first container image based on the first user's request to build the first container image. For example, the source code management device 120 may build the first container image through Docker. For example, when the first container image is generated, the source code management device 120 may be configured to change the build status of the first container image into “Completed” in the data storage device 140. For example, the source code management device 120 may be configured to store information about the build process of the first container image in the data storage device 140.

In operation S130, the source code management device 120 may push the first container image to the first container registry within a plurality of container registries based on the first user's request to push the first container image. For example, the source code management device 120 may include information about the first container registry, to which the first container image is to be pushed, in the first container image push request. For example, when the first container image is pushed, the source code management device 120 may be configured to change the push status of the first container image into “Completed” in the data storage device 140. For example, the source code management device 120 may be configured to store information about the push process of the first container image in the data storage device 140.

In operation S140, the user management device 130 may assign the access permission for the first container image to a second user based on a request signal of the first user related to the access permission of the second user for the first container image.

In operation S150, the user management device 130 may delete the second user's access permission for the first container image based on a request signal of the first user for deleting the access permission of the second user for the first container image.

In operations S110 to S150, the source code management device 120 may verify the validity of the data type and character pattern of the user ID, password, name, and email address of the first user and the second user before performing each operation, and may verify the validity of the data type and character pattern of the first source code and the first container image, and a file structure of the first source code and the first container image.

As described above, the container registry management system 100 may receive a source code from a user, may build a container image, and may push the built container image to a plurality of container registries. Moreover, the container registry management system 100 may easily manage a user capable of accessing each container image stored in the plurality of container registries.

Through the container registry management system 100 of the present disclosure, a container image build function may be provided while the plurality of container registries may be integrated and managed, thereby increasing the convenience of development for users and improving the scalability of container images. Furthermore, container images may be easily shared and managed between heterogeneous container registry users by providing a user sharing function for individual container images.

As used in this specification, the terms “device” or “unit” refer to any combination of software, firmware, and/or hardware configured to provide the functionality described in this specification. For example, the software may be implemented as a software package, codes and/or set of instructions, or instructions. For example, the hardware may include a single or any combination or assembly of firmware storing instructions executed by a hardwired circuit, a programmable circuit, a state machine circuit, and/or a programmable circuit.

The above description refers to detailed embodiments for implementing the present disclosure. The present disclosure may include embodiments in which a design is changed simply or which are easily changed, as well as the embodiments described above. In addition, technologies that are easily changed and implemented by using the above embodiments may be included in the present disclosure. Accordingly, it will be apparent to those of ordinary skill in the art that various changes and modifications may be made to the above embodiments without departing from the spirit and scope of the present disclosure as set forth in the following claims.

A container registry management system may receive a source code from a user, may build a container image, and may push the built container image to a plurality of container registries. Moreover, the container registry management system may easily manage a user capable of accessing each container image stored in the plurality of container registries.

Through the container registry management system of the present disclosure, a container image build function may be provided while the plurality of container registries may be integrated and managed, thereby increasing the convenience of development for users and improving the scalability of container images. Furthermore, container images may be easily shared and managed between heterogeneous container registry users by providing a user sharing function for individual container images.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A container registry management system, the system comprising:
a registry management device configured to manage a plurality of container registries;
a source code management device configured to receive a source code from a first user, to build a first container image based on a request signal of the first user for building the first container image, and to push the first container image to a first container registry within the plurality of container registries, based on a request signal of the first user for pushing the first container image;
a user management device configured to manage a first image access permission of a second user for the first container image based on a request signal of the first user related to an access permission of the second user for the first container image, and to manage a first access permission of the first user for the plurality of container registries and a second access permission of the second user for the plurality of container registries; and
a data storage device configured to store data related to the registry management device, the source code management device, and the user management device.

2. The system of claim 1, wherein the data storage device includes:
a user information storage device configured to store information about the first image access permission, the first access permission, and the second access permission;
a registry information storage device configured to store information about the plurality of container registries and password information about the plurality of container registries; and
a source code information storage device configured to store information about the source code and information about the first container image.

3. The system of claim 2, wherein the registry management device includes:
a registry adding device configured to add a second container registry and a password for the second container registry to the registry information storage device;
a registry modifying device configured to modify description information about the second container registry and the password for the second container registry in the registry information storage device; and
a registry deleting device configured to delete information about the second container registry from the registry information storage device, to delete a second container image stored in the second container registry from the source code information storage device, and to delete an access permission of a user for the second container image from the user information storage device.

4. The system of claim 3, wherein the registry management device further includes:
a registry operation verifying device configured to verify validity of administrator account information and an API address of the second container registry prior to operations of the registry adding device, the registry modifying device, and the registry deleting device.

5. The system of claim 2, wherein the user management device includes:
a user adding device configured to store an access permission of a third user for the plurality of container registries and user information about the third user in the user information storage device;
a user modifying device configured to modify information about the third user stored in the user information storage device;
a user deleting device configured to delete the information about the third user stored in the user information storage device;
an image member adding device configured to add the first image access permission of the second user for the first container image based on a request signal of the first user; and
an image member deleting device configured to delete the first image access permission based on the request signal of the first user.

6. The system of claim 5, wherein the user management device further includes:
a user information verifying device configured to verify validity of a data type and a character pattern of a user ID, a password, a name, and an email address of each of the first user, the second user, and the third user prior to operations of the user adding device, the user modifying device, the user deleting device, the image member adding device, and the image member deleting device.

7. The system of claim 2, wherein the source code management device includes:
a source code adding device configured to receive and store the source code from the first user in the source code information storage device;
a source code deleting device configured to delete the source code from the source code information storage device based on a request of the first user for deleting the source code;
an image building device configured to build the source code into the first container image based on a request signal of the first user for building the first container image;
an image pushing device configured to push the first container image to the first container registry based on a request signal of the first user for pushing the first container image; and
an image deleting device configured to delete the first container image from the first container registry based on a request signal of the first user for deleting the first container image and to delete information about the first container image from the source code information storage device.

8. The system of claim 7, wherein the source code management device further includes:
a source code and image verifying device configured to:
prior to operations of the source code adding device, the source code deleting device, the image building device, the image pushing device, and the image deleting device, verify validity of a data type and a character pattern of the source code and the first container image, and a file structure of the source code and the first container image.

9. A container registry management method of a container registry management system including a source code management device, a user management device, and a plurality of container registries, the method comprising:
receiving, by the source code management device, a source code from a first user;
building, by the source code management device, the source code into a first container image based on a request signal of the first user for building the first container image;
pushing, by the source code management device, the first container image to a first container registry within the plurality of container registries based on a request signal of the first user for pushing the first container image; and
assigning, by the user management device, an access permission for the first container image to a second user based on a request signal of the first user related to an access permission of the second user for the first container image.

10. The method of claim 9, further comprising:
deleting, by the user management device, the access permission of the second user for the first container image based on a request signal of the first user for deleting the access permission of the second user for the first container image.

11. The method of claim 10, further comprising:
verifying validity of data types, and character patterns of user IDs, passwords, names, and email addresses of the first user and the second user.

12. The method of claim 10, further comprising:
verifying validity of a data type and a character pattern of the source code and the first container image, and a file structure of the source code and the first container image.
